(19) United States
(12) Patent Application Publication
(10) Pub. No.: US 2026/0102812 A1
(43) Pub. Date: Apr. 16, 2026

(54) TUBE MANUFACTURING SUPPORT DEVICE AND TUBE MANUFACTURING METHOD

(71) Applicant: MITSUBISHI HEAVY INDUSTRIES, LTD., Tokyo (JP)

(72) Inventors: Masateru FUKUDA, Tokyo (JP); Daisuke Kamae, Tokyo (JP); Sumito Kajihara, Tokyo (JP); Tomohiro Matsuura, Tokyo (JP)

(21) Appl. No.: 19/354,296

(22) Filed: Oct. 9, 2025

(30) Foreign Application Priority Data
Oct. 15, 2024 (JP) 2024-179849

(51) Int. Cl. B21D 7/00

(52) U.S. Cl. CPC B21D 7/00

(57) ABSTRACT

A tube manufacturing support device includes a gate-shaped frame including a first column and a second column, and an upper beam that connects an upper end of the first column and an upper end of the second column, an upper pressing mechanism that is attached to the upper beam to be movable in a lateral direction along the upper beam, a first lateral pressing mechanism that is attached to the first column, a second lateral pressing mechanism that is attached to the second column, and a slider configured to support the plurality of metal plates constituting a tube to be movable in a depth direction between the first column and the second column. The upper pressing mechanism, the first lateral pressing mechanism, and the second lateral pressing mechanism are each capable of pressing any of the plurality of metal plates.

### BACKGROUND OF THE INVENTION

### Field of the Invention

The present disclosure relates to a tube manufacturing support device and a tube manufacturing method.

Priority is claimed on Japanese Patent Application No. 2024-179849, filed on October 15, 2024, the content of which is incorporated herein by reference.

### Description of the Related Art

Japanese Unexamined Patent Application, First Publication No. 2012-135802 discloses a method of manufacturing a cylindrical tube around a tube axis using a plurality of metal plates. The tube is manufactured by arranging a plurality of metal plates that extend in a tube axis direction along which a tube axis extends and that spread in a circumferential direction with respect to the tube axis around the tube axis in the circumferential direction and joining the plurality of metal plates to each other. In the method, the tube is manufactured using the tube manufacturing support device.

The tube manufacturing support device includes a gate-shaped frame and a jack. The gate-shaped frame includes a first column and a second column that extend in a vertical direction and are disposed on a work floor at intervals in a lateral direction, and an upper beam that extends in the lateral direction to connect an upper end of the first column and an upper end of the second column. The jack is attached to the upper beam in a movable manner along the upper beam via a jig.

Each of the plurality of metal plates has an edge that faces the circumferential direction and extends in the tube axis direction. In a process of manufacturing the tube, even in a case where edges of two metal plates adjacent to each other in the circumferential direction are made to be adjacent to each other, a part of an edge of the other metal plate may be deviated in a radial direction with respect to the tube axis from a part of an edge of one metal plate, so that the part of the edge of the other metal plate may not face the part of the edge of the one metal plate in the circumferential direction.

In such a case, in the manufacturing method described in Japanese Unexamined Patent Application, First Publication No. 2012-135802, for example, a portion along a part of the edge of one metal plate is pushed radially inward with respect to the tube axis with the jack of the tube manufacturing support device to face the part of the edge of the one metal plate and the part of the edge of the other metal plate in the circumferential direction. Then, while maintaining this state, the part of the edge of one metal plate and the part of the edge of the other metal plate are joined to each other. Further, after moving two metal plates in the depth direction perpendicular to the vertical direction and the lateral direction with respect to the gate-shaped frame, for example, a portion along the other part of the edge of one metal plate is pushed radially inward with respect to the tube axis with the jack of the tube manufacturing support device to face the other part of the edge of the one metal plate and the other part of the edge of the other metal plate in the circumferential direction. Then, while maintaining this state, the other part of the edge of one metal plate and the other part of the edge of the other metal plate are joined to each other. The above-described operation is repeatedly executed to join the entire edge of the one metal plate extending in the tube axis direction to the edge of the other metal plate.

### Citation List

### Patent Document

Patent Document 1: Japanese Unexamined Patent Application, First Publication No. 2012-135802

### SUMMARY OF THE INVENTION

In the technology described in Japanese Unexamined Patent Application, First Publication No. 2012-135802, in a case in which a portion along a part of the edge of one metal plate is pushed with the jack, it is necessary to support the two entire metal plates such that the two entire metal plates do not move or tilt with a pressing force of the jack. In addition, in the process of joining the edges of the two metal plates to each other, it is necessary to move the two metal plates integrally in the depth direction with respect to the gate-shaped frame. Therefore, in the technology described in Japanese Unexamined Patent Application, First Publication No. 2012-135802, the worker is burdened.

Therefore, an object of the present disclosure is to provide a tube manufacturing support device and a tube manufacturing method capable of reducing the burden on a worker in tube manufacturing.

A tube manufacturing support device according to one aspect for achieving the object is used in a case of manufacturing a tube by arranging a plurality of metal plates extending in a tube axis direction along which a tube axis extends and spreading in a circumferential direction with respect to the tube axis, in the circumferential direction around the tube axis, and joining metal plates adjacent to each other in the circumferential direction among the plurality of metal plates.

A tube manufacturing support device includes a gate-shaped frame including a first column and a second column that extend in a vertical direction and are disposed at intervals in a lateral direction, and an upper beam that extends in the lateral direction and connects an upper end of the first column and an upper end of the second column, a slider configured to support the plurality of metal plates to be movable in a depth direction perpendicular to the lateral direction and the vertical direction between the first column and the second column, an upper pressing mechanism that is attached to the upper beam to be movable in the lateral direction along the upper beam and is configured to press any one of the plurality of metal plates supported by the slider, a first lateral pressing mechanism that is attached to the first column and is configured to press any one of the plurality of metal plates supported by the slider, and a second lateral pressing mechanism that is attached to the second column and is configured to press any one of the plurality of metal plates supported by the slider.

In a case in which the tube is manufactured using the tube manufacturing support device of the present aspect, the first metal plate and the second metal plate among the plurality of metal plates are arranged to be adjacent to the first metal plate in the circumferential direction (joint plate disposition step). Next, the temporary assembly plate group including the first metal plate and the second metal plate is moved in the depth direction on the slider so that a position of the edge of the second metal plate to be joined to the edge of the first metal plate in the tube axis direction is located at a work position under the upper beam, thereby adjusting a position of the temporary assembly plate group (position adjustment step). In the present aspect, in the position adjustment step, in a case in which the temporary assembly plate group is slid in the depth direction, the temporary assembly plate group is slid on the slider, whereby the burden on the worker in the position adjustment step can be reduced.

Next, the first lateral pressing mechanism and the second lateral pressing mechanism are operated to sandwich the temporary assembly plate group positioned at the work position between the first lateral pressing mechanism and the second lateral pressing mechanism, and restricting movement of the temporary assembly plate group (movement restriction step). In a case in which the movement restriction step is executed, the temporary assembly plate group is restricted from moving in the lateral direction and the depth direction, and an inclination of the tube axis and an inclination around the tube axis are restricted.

Next, during execution of the movement restriction step, one portion of a portion along a part of the edge of the first metal plate extending in the tube axis direction and a portion along a part of the edge of the second metal plate extending in the tube axis direction is pressed by the upper pressing mechanism, thereby causing the part of the edge of the first metal plate and the part of the edge of the second metal plate to face each other in the circumferential direction (edge facing treatment step). Since the edge facing treatment step is executed during the execution of the movement restriction step, the edge facing treatment step can be executed in a state in which the movement or inclination of the temporary assembly plate group is restricted. Then, the part of the edge of the first metal plate and the part of the edge of the second metal plate during execution of the movement restriction step and during execution of the edge facing treatment step are joined (joining step). Since the joining step is executed during the execution of the movement restriction step, the joining step can be executed in a state in which the movement or inclination of the temporary assembly plate group is restricted. Therefore, in the present aspect, the burden on the worker in the edge facing treatment step and the joining step can be reduced.

In a tube manufacturing method according to one aspect for achieving the object, the tube manufacturing support device according to the one aspect is used.

The manufacturing method includes a preparation step of preparing the plurality of metal plates, and, out of a first axial side and a second axial side in the tube axis direction, a first auxiliary metal plate corresponding to an internal size and an internal shape of the tube on the first axial side, and a second auxiliary metal plate corresponding to an internal size and an internal shape of the tube on the second axial side, a temporary joining step of temporarily joining, among the plurality of metal plates, a first metal plate and a third metal plate facing each other across the tube axis to a part of an edge of the first auxiliary metal plate and a part of an edge of the second auxiliary metal plate such that a relative positional relationship between the first metal plate and the third metal plate matches a relative positional relationship between the first metal plate and the third metal plate after the tube is manufactured, a placing step of placing the first metal plate and the third metal plate temporarily joined to the first auxiliary metal plate and the second auxiliary metal plate on the slider such that the tube axis extends in the depth direction, a joint plate disposition step of disposing, among the plurality of metal plates, an edge of a second metal plate, excluding the first metal plate and the third metal plate, the edge facing the circumferential direction and extending in the tube axis direction, to be adjacent to an edge of one metal plate of the first metal plate and the third metal plate, which is temporarily joined to the first auxiliary metal plate and the second auxiliary metal plate, the edge facing the circumferential direction and extending in the tube axis direction, a position adjustment step of moving, in the depth direction on the slider, a temporary assembly plate group that is a set of the first auxiliary metal plate, the second auxiliary metal plate, the first metal plate, the second metal plate, and the third metal plate, so that a position of the edge of the second metal plate to be joined to the edge of the one metal plate in the tube axis direction is located at a work position under the upper beam, thereby adjusting a position of the temporary assembly plate group, a movement restriction step of operating the first lateral pressing mechanism and the second lateral pressing mechanism to sandwich the temporary assembly plate group positioned at the work position between the first lateral pressing mechanism and the second lateral pressing mechanism, thereby restricting movement of the temporary assembly plate group, an edge facing treatment step of pressing, during execution of the movement restriction step, one of a portion along a part of the edge of the one metal plate extending in the tube axis direction and a portion along a part of the edge of the second metal plate extending in the tube axis direction by the upper pressing mechanism, thereby causing the part of the edge of the one metal plate and the part of the edge of the second metal plate to face each other in the circumferential direction, a joining step of joining the part of the edge of the one metal plate and the part of the edge of the second metal plate during execution of the movement restriction step and during execution of the edge facing treatment step, and an auxiliary plate removal step of removing the first auxiliary metal plate and the second auxiliary metal plate from the first metal plate and the third metal plate after the plurality of metal plates are connected to each other. The position adjustment step, the movement restriction step, the edge facing treatment step, and the joining step are repeated until an entirety of the edge of the second metal plate extending in the tube axis direction is joined to the edge of the one metal plate.

In the tube manufacturing method according to the present aspect, the tube manufacturing support device according to the one aspect is used, so that the burden on a worker can be suppressed in manufacturing the tube.

In the present aspect of the present disclosure, the burden on a worker can be suppressed in manufacturing a tube.

### BRIEF DESCRIPTION OF THE DRAWINGS

FIG. 1 is a perspective view of a tube according to an embodiment of the present disclosure.

FIG. 2 is a plan view of a tube manufacturing support device according to the embodiment of the present disclosure.

FIG. 3 is a side view of the tube manufacturing support device according to the embodiment of the present disclosure.

FIG. 4 is a front view of the tube manufacturing support device according to the embodiment of the present disclosure.

FIG. 5 is a front view of a main portion of the tube manufacturing support device according to the embodiment of the present disclosure.

FIG. 6 is an explanatory diagram showing a configuration of a first support frame moving mechanism according to the embodiment of the present disclosure.

FIG. 7 is an explanatory diagram showing a configuration of a first base swing mechanism according to the embodiment of the present disclosure.

FIG. 8 is a cross-sectional view taken along a line VIII-VIII in FIG. 5.

FIG. 9 is a flowchart showing a manufacturing procedure of a tube according to the embodiment of the present disclosure.

FIG. 10 is a perspective view of a temporary assembly plate group according to the embodiment of the present disclosure.

FIG. 11 is a plan view of the tube manufacturing support device and the temporary assembly plate group after the position adjustment step is completed according to the embodiment of the present disclosure.

FIG. 12 is a front view of the tube manufacturing support device and the temporary assembly plate group after the movement restriction step is completed according to the embodiment of the present disclosure.

FIG. 13 is an explanatory diagram showing a state of a plurality of metal plates immediately before an edge facing treatment step according to the embodiment of the present disclosure.

FIG. 14 is an explanatory diagram showing a state of the plurality of metal plates after the edge facing treatment step according to the embodiment of the present disclosure.

### DETAILED DESCRIPTION OF THE INVENTION

Hereinafter, an embodiment of a tube manufacturing support device according to the present invention and a tube manufacturing method using the tube manufacturing support device will be described with reference to the drawings.

### Embodiment of Tube

First, an embodiment of a tube to be manufactured will be described.

The tube according to the present embodiment is a tube constituting a part of a combustor of a gas turbine. The combustor includes a burner that jets fuel and air and a combustion tube (or a tail tube) that defines a combustion space in which the fuel jetted from the burner is combusted, and the tube according to the present embodiment is the combustion tube.

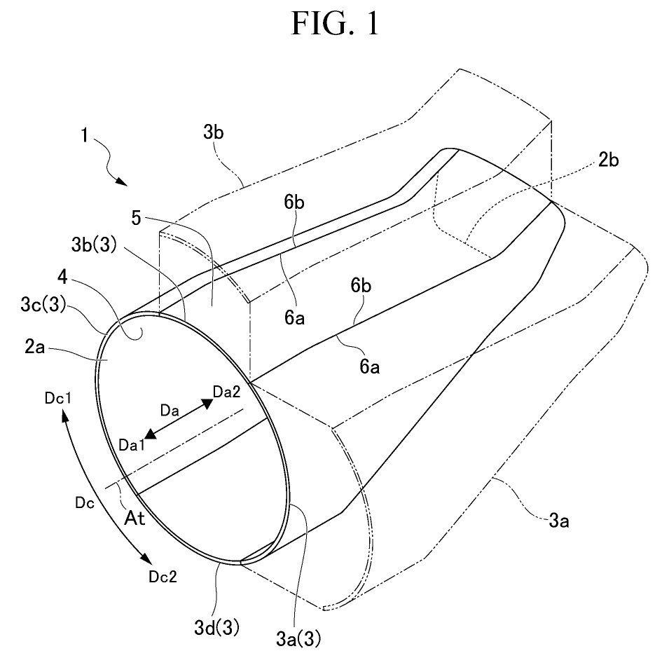

As shown in FIG. 1, the tube 1 according to the present embodiment is tube-shaped around a tube axis At. Here, a direction along which the tube axis At extends is defined as a tube axis direction Da, one side of both sides in the tube axis direction Da is defined as a first axial side Da1, and the other side is defined as a second axial side Da2. In addition, a circumferential direction with respect to the tube axis At is defined as a circumferential direction Dc, one side of both sides in the circumferential direction Dc is defined as a first circumferential side Dc1, and the other side is defined as a second circumferential side Dc2.

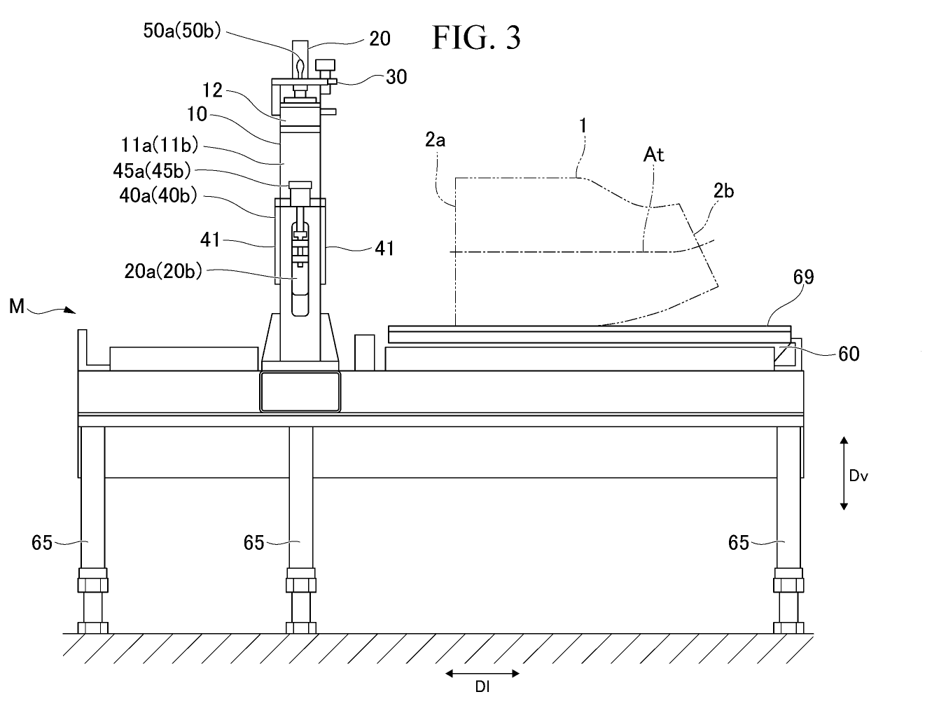

The tube axis At of the tube 1 according to the present embodiment is not a straight line, but is curved as shown in FIG. 3. As shown in FIG. 1, a first opening that is open from an inside toward the first axial side Da1 is formed at an end of the tube 1 on the first axial side Da1. A second opening that is open from the inside toward the second axial side Da2 is formed at an end of the tube 1 on the second axial side Da2. A cross section of the tube 1 on a virtual plane perpendicular to the tube axis At has a different cross-sectional shape and a different cross-sectional size depending on a position in the tube axis direction Da. For example, the cross-sectional shape at the end of the tube 1 on the first axial side Da1 is circular. In addition, the cross-sectional shape at the end of the tube 1 on the second axial side Da2 is an isosceles trapezoidal shape, and the cross-sectional size thereof is smaller than the cross-sectional size at the end of the tube 1 on the first axial side Da1.

The tube 1 according to the present embodiment is manufactured by joining the plurality of metal plates 3 to each other. The number of metal plates 3 according to the present embodiment is four. All of the plurality of metal plates 3 are plates that extend in the tube axis direction Da and the circumferential direction Dc. However, all of the plurality of metal plates 3 are not flat plates, but are curved. All of the plurality of metal plates 3 include an inner peripheral surface 4 that forms a part of the inner peripheral surface of the tube 1, an outer peripheral surface 5 that forms a part of the outer peripheral surface of the tube 1, and an edge 6. The edge 6 includes a first edge 6a that faces the first circumferential side Dc1 and extends in the tube axis direction Da, and a second edge 6b that faces the second circumferential side Dc2 and extends in the tube axis direction Da. The plurality of metal plates 3 are arranged around the tube axis At in the circumferential direction Dc, and the edges 6 of the metal plates 3 adjacent to each other in the circumferential direction Dc among the plurality of metal plates 3 are joined to each other.

As described above, the tube 1 according to the present embodiment is a combustion tube (or a tail tube). However, the tube 1 may be any tube as long as a tube in which a plurality of metal plates 3 extending in the tube axis direction Da along which the tube axis At extends and spreading in the circumferential direction Dc relative to the tube axis At are arranged in the circumferential direction Dc around the tube axis At and the plurality of metal plates 3 are joined together.

### Embodiment of Tube Manufacturing Support Device

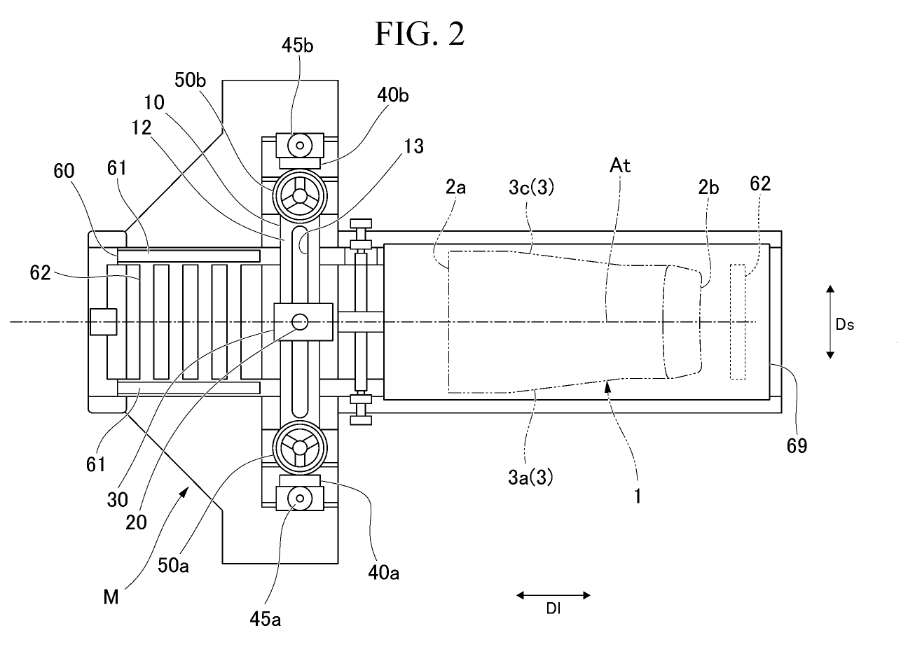

An embodiment of the tube manufacturing support device will be described with reference to FIGS. 2 to 8.

As shown in FIGS. 2 to 4, a tube manufacturing support device M according to the present embodiment includes a gate-shaped frame 10, an upper pressing mechanism 20, a first lateral pressing mechanism 20a, a second lateral pressing mechanism 20b, an upper base support frame 30, a first base support frame 40a, a second base support frame 40b, a first base swing mechanism 45a, a second base swing mechanism 45b, a first support frame moving mechanism 50a, a second support frame moving mechanism 50b, a slider 60, and a plurality of legs 65.

The gate-shaped frame 10 includes a first column 11a and a second column 11b that extend in a vertical direction Dv and are disposed at intervals in a lateral direction Ds, and an upper beam 12 that extends in the lateral direction Ds and connects an upper end of the first column 11a and an upper end of the second column 11b. The upper beam 12 is formed with a guide hole 13 that penetrates in the vertical direction Dv and extends in the lateral direction Ds. The upper beam 12 is curved such that a portion including a range in which the guide hole 13 is formed gradually inclines upward in the vertical direction from the first column 11a toward a center of the upper beam 12 in the lateral direction, and gradually inclines upward in the vertical direction from the second column 11b toward the center.

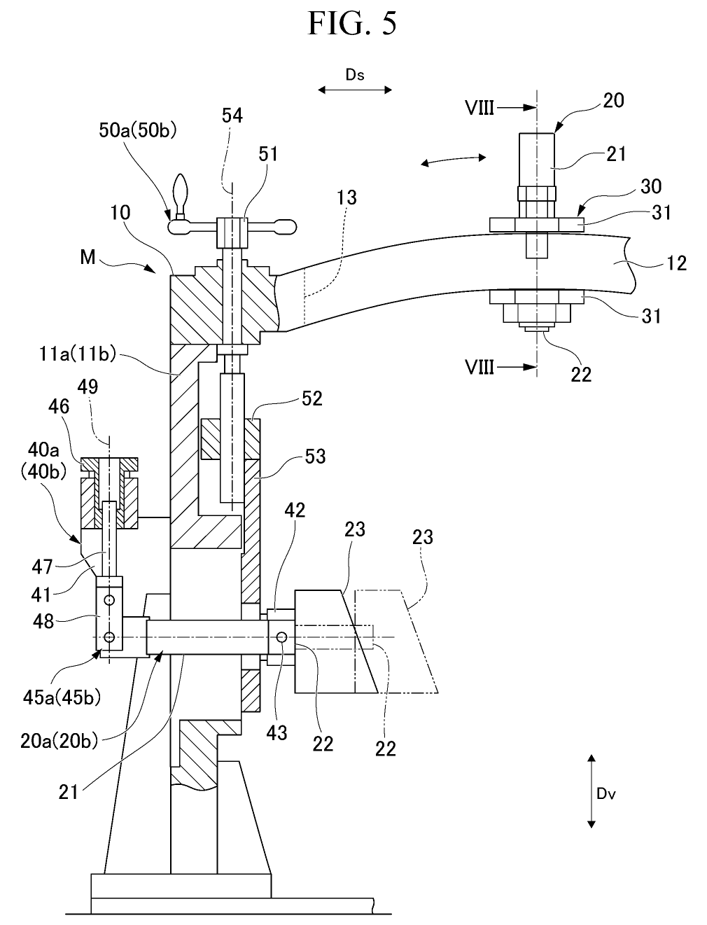

As shown in FIG. 5, the upper pressing mechanism 20, the first lateral pressing mechanism 20a, and the second lateral pressing mechanism 20b each include a base 21 and a distal end 22 that is movable relative to the base 21 in a distal end moving direction. Specifically, the upper pressing mechanism 20, the first lateral pressing mechanism 20a, and the second lateral pressing mechanism 20b are all hydraulic cylinders that move the distal end 22 by hydraulic pressure. The hydraulic cylinder includes a piston rod and a cylinder casing. The piston rod extends in the distal end moving direction and has the distal end 22 that is an end of the distal end moving direction. The cylinder casing constitutes the base 21 of each pressing mechanism 20, 20a, 20b and covers the piston rod in a state where the distal end 22 is exposed so that the piston rod is movable in the distal end moving direction. A contact end 23 that is capable of coming into contact with any of the metal plates 3 constituting the tube 1 is attached to the distal end 22 of the first lateral pressing mechanism 20a and the distal end 22 of the second lateral pressing mechanism 20b.

The base 21 of the upper pressing mechanism 20 is attached to the upper beam 12 via the upper base support frame 30 such that the distal end moving direction has a component in the vertical direction Dv and the distal end 22 of the upper pressing mechanism 20 faces downward.

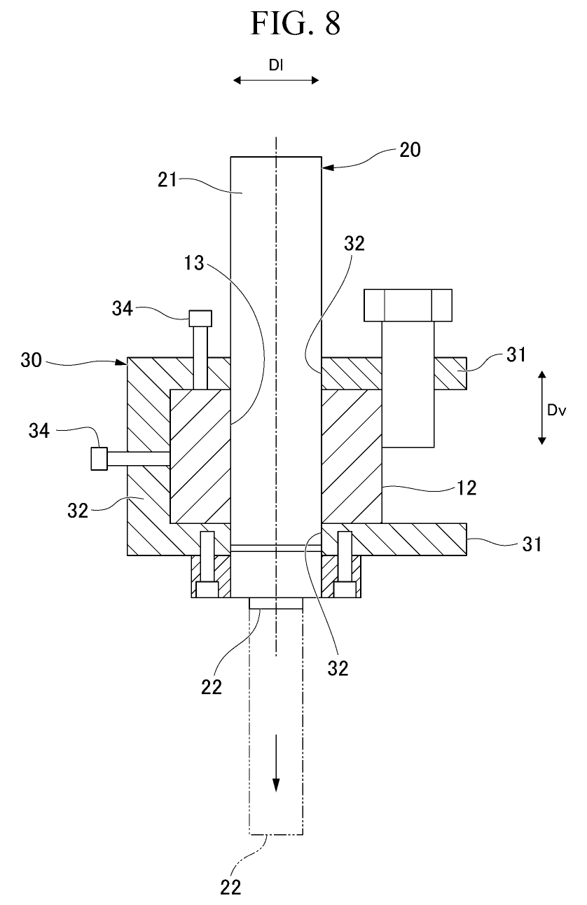

As shown in FIGS. 5 and 8, the upper base support frame 30 is a groove-shaped member having a pair of side plates 31 that face each other with a space therebetween, and a bottom plate 33 that connects ends of the pair of side plates 31 to each other. A base insertion hole 32 penetrating the pair of side plates 31 in a direction in which the pair of side plates 31 are arranged is formed in each of the pair of side plates 31. The upper base support frame 30 is disposed to be movable in the lateral direction Ds with respect to the upper beam 12 with the upper beam 12 positioned between the pair of side plates 31. The base 21 of the upper pressing mechanism 20 is fixed to the upper base support frame 30 in a state of being inserted into the base insertion hole 32 formed in each of the pair of side plates 31 and the guide hole 13 of the upper beam 12. Therefore, the upper base support frame 30 and the base 21 of the upper pressing mechanism 20 supported by the upper base support frame 30 are movable in the lateral direction Ds with respect to the upper beam 12 within a range in which the guide hole 13 is formed in the upper beam 12. A lateral movement restriction bolt 34 for restricting the lateral movement of the upper beam 12 in the lateral direction Ds is provided on the upper base support frame 30.

The base 21 of the first lateral pressing mechanism 20a is attached to the first column 11a via the first base support frame 40a such that the distal end moving direction has a component in the lateral direction Ds and the distal end 22 of the first lateral pressing mechanism 20a faces toward the second column 11b. The base 21 of the first lateral pressing mechanism 20a is attached to the first base support frame 40a to be swingable by the first base swing mechanism 45a. The first base support frame 40a is attached to the first column 11a to be movable in the vertical direction Dv by the first support frame moving mechanism 50a.

The base 21 of the second lateral pressing mechanism 20b is attached to the second column 11b via the second base support frame 40b such that the distal end moving direction has a component in the lateral direction Ds and the distal end 22 of the second lateral pressing mechanism 20b faces toward the first column 11a. The base 21 of the second lateral pressing mechanism 20b is attached to the second base support frame 40b to be swingable by the second base swing mechanism 45b. The second base support frame 40b is attached to the second column 11b to be movable in the vertical direction Dv by the second support frame moving mechanism 50b.

The second base support frame 40b has the same configuration as the first base support frame 40a except that the orientation of the second base support frame 40b in the lateral direction Ds is opposite to the orientation of the first base support frame 40a. The second base swing mechanism 45b has the same configuration as the first base swing mechanism 45a except that the orientation of the second base swing mechanism 45b in the lateral direction Ds is opposite to the orientation of the first base swing mechanism 45a. The second support frame moving mechanism 50b has the same configuration as the first support frame moving mechanism 50a except that the orientation of the second support frame moving mechanism 50b in the lateral direction Ds is opposite to the orientation of the first support frame moving mechanism 50a. Therefore, hereinafter, only the configurations of the first base support frame 40a, the first base swing mechanism 45a, and the first support frame moving mechanism 50a will be described, and the descriptions of the configurations of the second base support frame 40b, the second base swing mechanism 45b, and the second support frame moving mechanism 50b will be omitted.

As shown in FIG. 5, the first base support frame 40a includes a pair of support plates 41 (see FIGS. 3 and 5) that are disposed to sandwich the first column 11a in the depth direction Dl perpendicular to the vertical direction Dv and the lateral direction Ds, and a base holding ring 42. The base holding ring 42 holds a portion of the base 21 of the first lateral pressing mechanism 20a on the distal end 22 side. The base holding ring 42 has a swing shaft 43 extending in the depth direction Dl. The base holding ring 42 is attached to the pair of support plates 41 to be rotatable about the swing shaft 43 together with the base 21 of the first lateral pressing mechanism 20a held by the base holding ring 42.

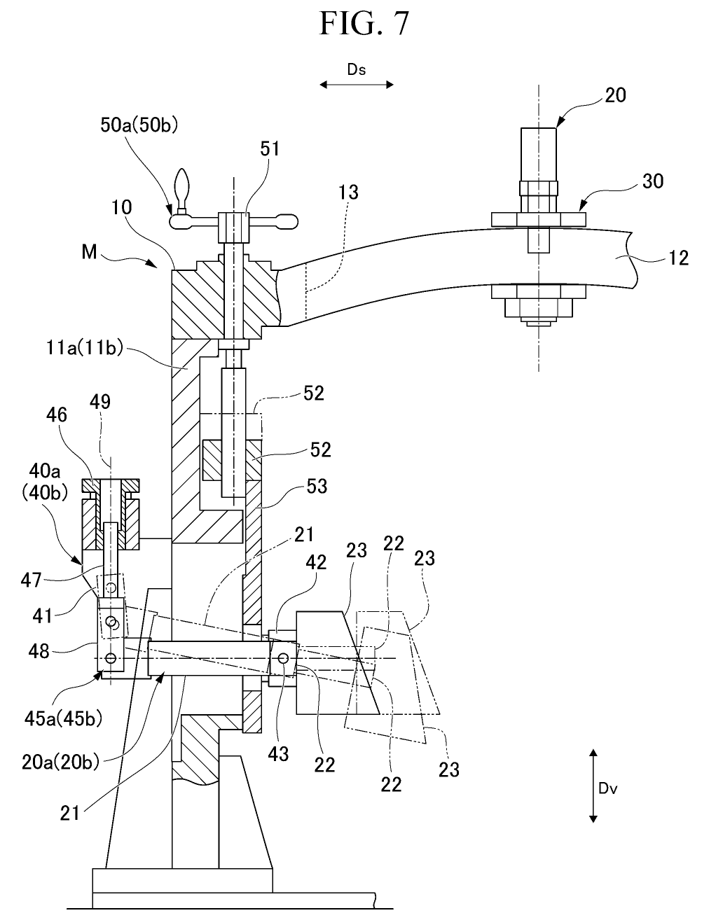

As shown in FIGS. 5 and 7, the first base swing mechanism 45a includes a swing operation end 46, a swing screw 47, and a swing link mechanism 48. The swing operation end 46 is provided on the pair of support plates 41 to be rotatable about a swing screw axis 49 extending in the vertical direction Dv. A female screw hole that penetrates the vertical direction Dv about the swing screw axis 49 is formed in the swing operation end 46. The swing screw 47 is screwed into the female screw hole of the swing operation end 46. Therefore, in a case where the swing operation end 46 is rotated about the swing screw axis 49, the swing screw 47 moves relatively in the vertical direction Dv with respect to the swing operation end 46. A part of the swing link mechanism 48 is connected to the distal end of the swing screw 47. In addition, another part of the swing link mechanism 48 is connected to the base 21 of the first lateral pressing mechanism 20a on the proximal end side. Therefore, by operating the swing operation end 46, the base 21 of the first lateral pressing mechanism 20a swings about the swing shaft 43.

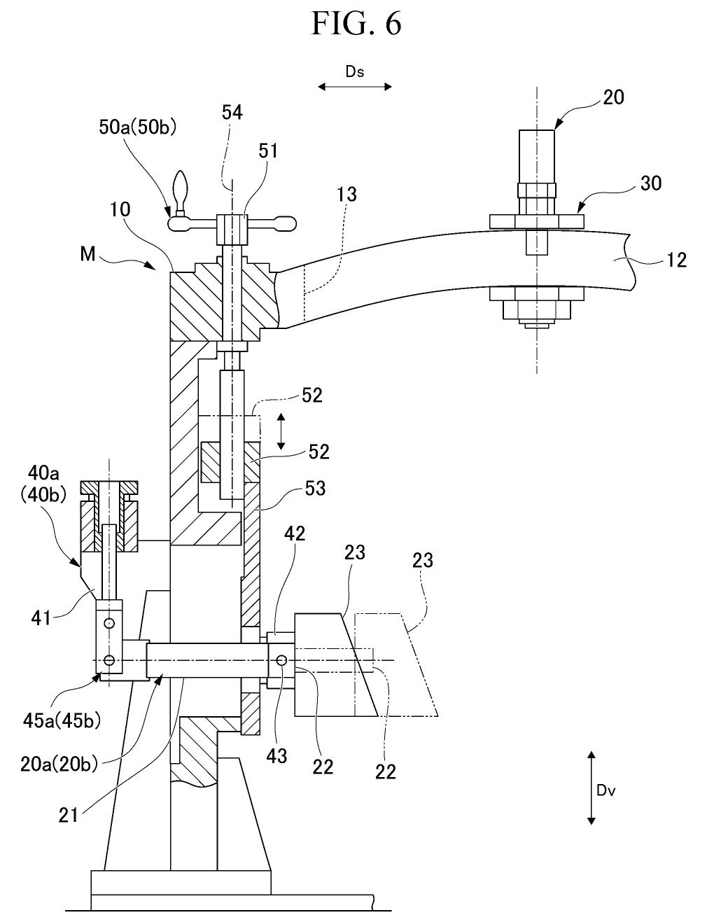

As shown in FIGS. 5 and 6, the first support frame moving mechanism 50a includes a moving operation end 51, a female screw member 52, and a connecting member 53. The moving operation end 51 is provided on the upper beam 12 to be rotatable about a moving screw axis 54 extending in the vertical direction Dv. An upper end of the moving operation end 51 in the vertical direction is positioned above the upper beam 12 to form an operation portion. In addition, a lower end of the moving operation end 51 in the vertical direction is positioned below the upper beam 12 to form a male screw. A female screw hole that penetrates the vertical direction Dv about the moving screw axis 54 is formed in the female screw member 52. The male screw of the moving operation end 51 is screwed into the female screw hole. Therefore, in a case where the moving operation end 51 is rotated about the moving screw axis 54, the female screw member 52 moves relatively in the vertical direction Dv with respect to the moving operation end 51. The connecting member 53 connects the female screw member 52 and the pair of support plates 41. Therefore, by operating the moving operation end 51, the first base support frame 40a having the pair of support plates 41, the base 21 of the first lateral pressing mechanism 20a supported by the first base support frame 40a, and the first base swing mechanism 45a provided on the first base support frame 40a integrally move in the vertical direction Dv along the first column 11a.

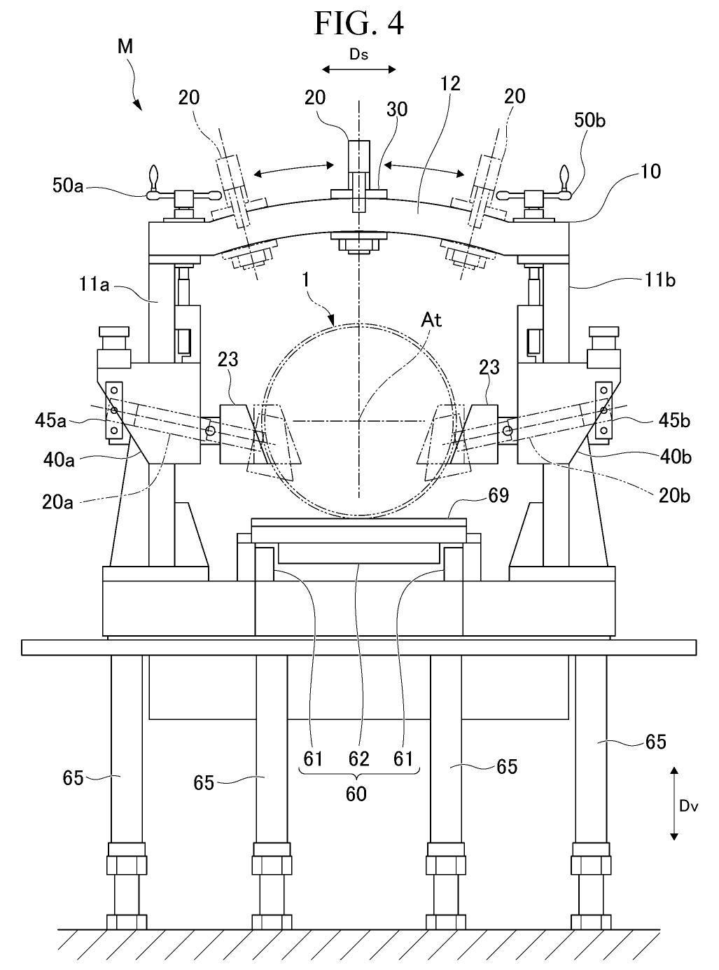

As shown in FIGS. 2 and 4, the slider 60 can support a component to be movable in the depth direction Dl between the first column 11a and the second column 11b. Here, “the component to be movable in the depth direction Dl” means that it is possible to move an object with much less effort than moving the object in the vertical direction Dv and the lateral direction Ds. The slider 60 is a roller conveyor including a pair of roller guides 61 and a plurality of rollers 62. The pair of roller guides 61 extends in the depth direction Dl and is disposed between the first column 11a and the second column 11b with a space therebetween in the lateral direction Ds. The plurality of rollers 62 are arranged in the depth direction Dl, are disposed between the pair of roller guides 61, and are supported by the pair of roller guides 61 to be rotatable about a roller 62 axis extending in the lateral direction Ds.

The plurality of legs 65 support the gate-shaped frame 10 and the slider 60.

### Embodiment of Tube Manufacturing Method

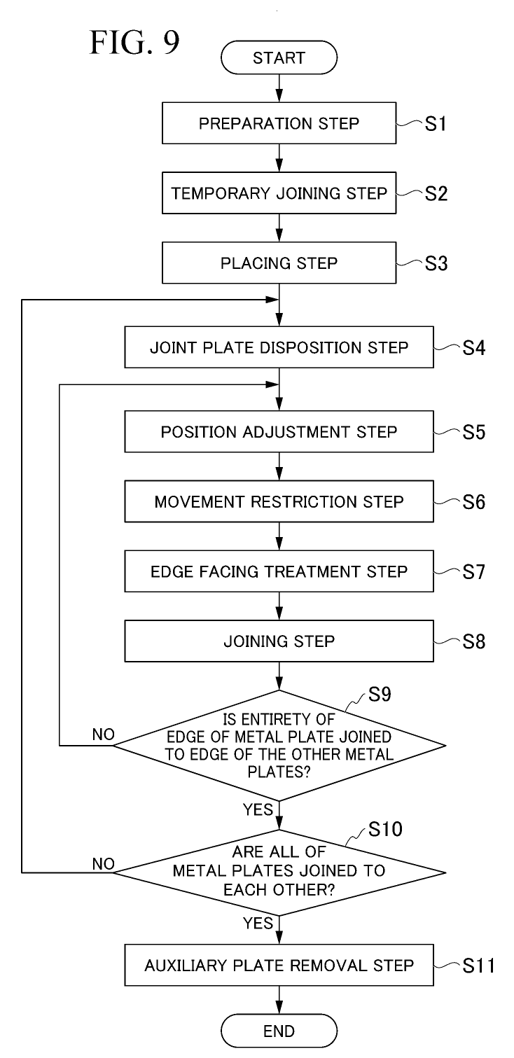

An embodiment of a manufacturing method of the tube 1 using the tube manufacturing support device M described above will be described with reference to a flowchart shown in FIG. 9.

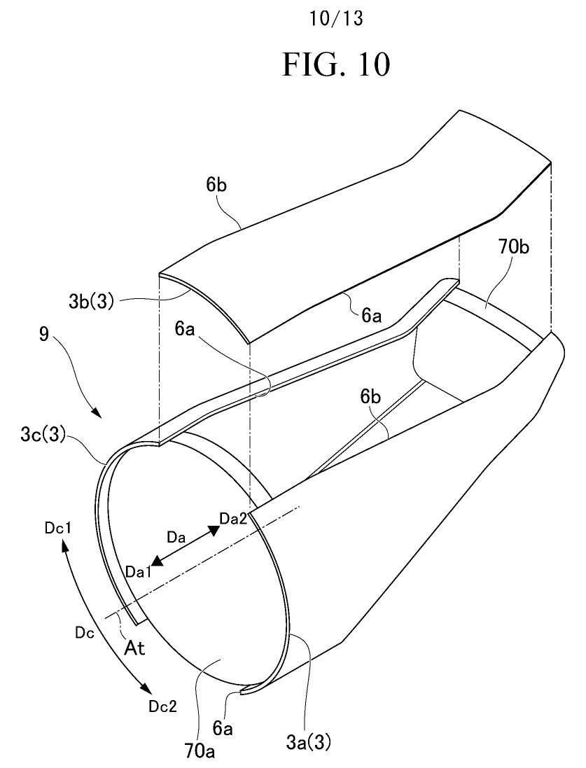

First, as shown in FIG. 10, four metal plates 3 constituting the tube 1, a first auxiliary metal plate 71a, and a second auxiliary metal plate 71b are prepared (preparation step S1). The first auxiliary metal plate 71a is a circular metal plate according to an internal size and an internal shape of the first axial side Da1 of the tube 1. In addition, the second auxiliary metal plate 71b is a trapezoidal metal plate according to an internal size and an internal shape of the second axial side Da2 of the tube 1.

Next, among the plurality of metal plates 3, the first metal plate 3a and the third metal plate 3c that face each other across the tube axis At are temporarily joined to a part of the edge of the first auxiliary metal plate 71a and a part of the edge of the second auxiliary metal plate 71b (temporary joining step S2). By executing the temporary joining step S2, the relative positional relationship between the first metal plate 3a and the third metal plate 3c substantially matches the relative positional relationship between the first metal plate 3a and the third metal plate 3c in the tube 1 in a completed state.

Next, as shown in FIG. 2, the first metal plate 3a and the third metal plate 3c temporarily joined to the first auxiliary metal plate 71a and the second auxiliary metal plate 71b are placed on the slider 60 together with the first auxiliary metal plate 71a and the second auxiliary metal plate 71b such that the tube axis At extends in the depth direction Dl and the first metal plate 3a is located on the side of the first column 11a with respect to the third metal plate 3c (placing step S3). In FIG. 2, the work plate 69 is placed on the slider 60, and the first metal plate 3a and the second metal plate 3b temporarily joined to the first auxiliary metal plate 71a and the second auxiliary metal plate 71b are placed on the work plate 69 together with the first auxiliary metal plate 71a and the second auxiliary metal plate 71b.

Next, as shown in FIG. 10, the first edge 6a of the second metal plate 3b, facing the first circumferential side Dc1 and extending in the tube axis direction Da is made to be adjacent to the second edge 6b of the first metal plate 3a temporarily joined to the first auxiliary metal plate 71a and the second auxiliary metal plate 71b, facing the second circumferential side Dc2 and extending in the tube axis direction Da (joint plate disposition step S4). In the joint plate disposition step S4, the second edge 6b of the second metal plate 3b may be adjacent to the first edge 6a of the third metal plate 3c temporarily joined to the first auxiliary metal plate 71a and the second auxiliary metal plate 71b. Here, a group of the first auxiliary metal plate 71a, the second auxiliary metal plate 71b, the first metal plate 3a, the third metal plate 3c, and the second metal plate 3b that is a joining plate to the first metal plate 3a is defined as a temporary assembly plate group 9.

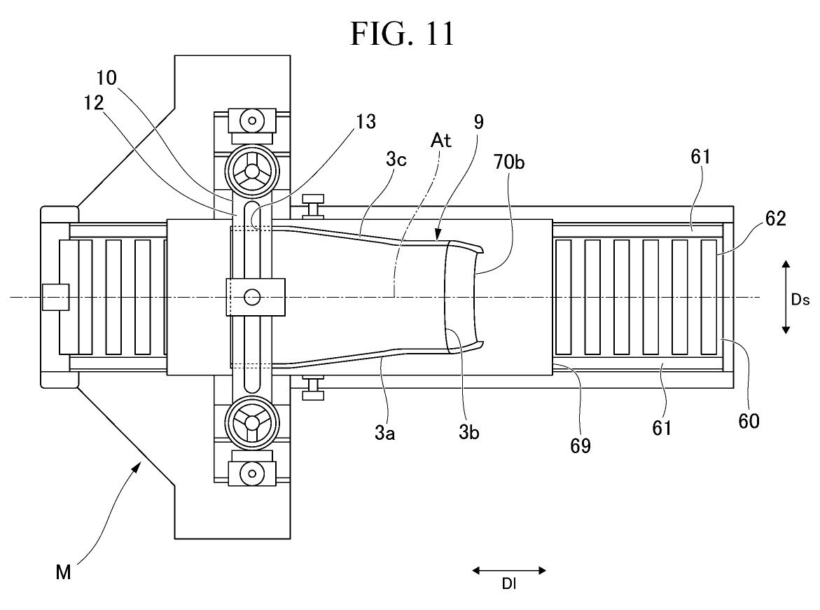

Next, as shown in FIG. 11, the temporary assembly plate group 9 is slid on the slider 60 in the depth direction Dl so that a position of the first edge 6a of the second metal plate 3b to be joined to the second edge 6b of the first metal plate 3a in the tube axis direction Da is located at a work position under the upper beam 12, thereby adjusting the position of the temporary assembly plate group 9 (position adjustment step S5). The joint plate disposition step S4 may be executed at any timing before the position adjustment step S5 and after the temporary joining step S2.

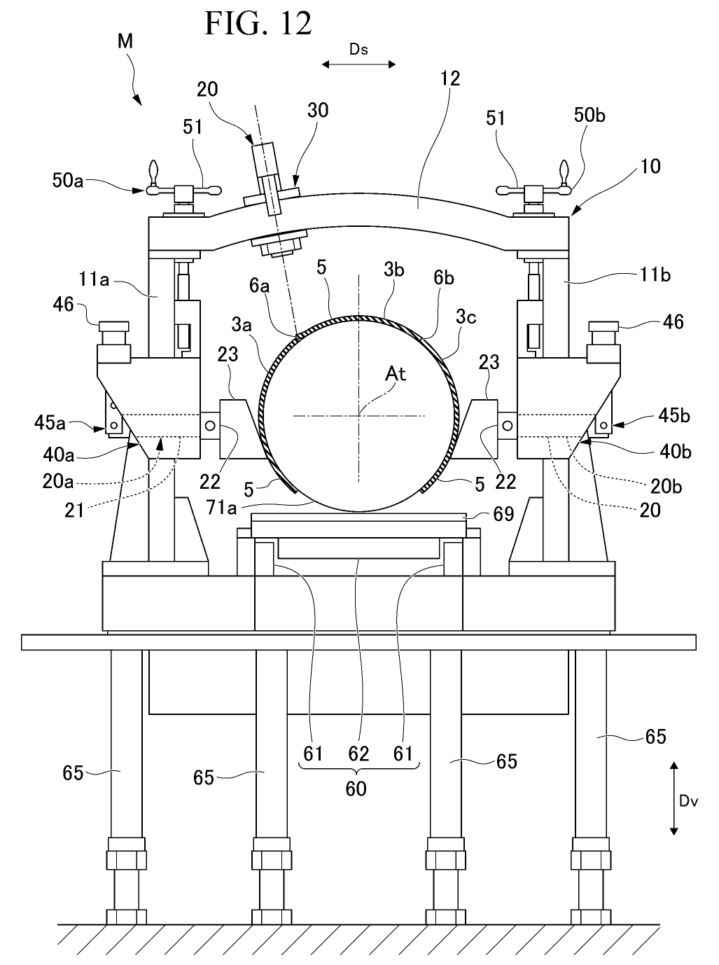

Next, as shown in FIG. 12, the first lateral pressing mechanism 20a and the second lateral pressing mechanism 20b are operated to execute a movement restriction step S6. In the movement restriction step S6, first, the moving operation end 51 of the first support frame moving mechanism 50a is operated such that the contact end 23 provided at the distal end 22 of the first lateral pressing mechanism 20a faces the first metal plate 3a in the lateral direction Ds, and the position of the base 21 of the first lateral pressing mechanism 20a in the vertical direction Dv is adjusted. Further, the swing operation end 46 of the first base swing mechanism 45a is operated to adjust the inclination of the base 21 of the first lateral pressing mechanism 20a. In addition, the moving operation end 51 of the second support frame moving mechanism 50b is operated such that the contact end 23 provided at the distal end 22 of the second lateral pressing mechanism 20b faces the third metal plate 3c in the lateral direction Ds, and the position of the base 21 of the second lateral pressing mechanism 20b in the vertical direction Dv is adjusted. Further, the swing operation end 46 of the second base swing mechanism 45b is operated to adjust the inclination of the base 21 of the second lateral pressing mechanism 20b. Next, the distal end 22 of the first lateral pressing mechanism 20a is moved with respect to the base 21 of the first lateral pressing mechanism 20a, and the distal end 22 of the second lateral pressing mechanism 20b is moved with respect to the base 21 of the second lateral pressing mechanism 20b, whereby the temporary assembly plate group 9 is sandwiched between the distal end 22 of the first lateral pressing mechanism 20a and the distal end 22 of the second lateral pressing mechanism 20b. In this case, the contact end 23 provided at the distal end 22 of the first pressing mechanism is in contact with the outer peripheral surface 5 of the first metal plate 3a in the temporary assembly plate group 9, and the contact end 23 provided at the distal end 22 of the second pressing mechanism is in contact with the outer peripheral surface 5 of the second metal plate 3b in the temporary assembly plate group 9.

In a case in which the movement restriction step S6 is executed, the temporary assembly plate group 9 is restricted from moving in the lateral direction Ds and the depth direction Dl, and an inclination of the tube axis At and an inclination around the tube axis At are restricted.

Next, as shown in FIGS. 12 to 14, during the execution of the movement restriction step S6, a part of the outer peripheral surface 5 of the second metal plate 3b along a position of the first edge 6a of the second metal plate 3b to be joined to the second edge 6b of the first metal plate 3a in the tube axis direction Da is pressed by the upper pressing mechanism 20 in a direction having a component in the vertical downward direction. In this case, in order to prevent the outer peripheral surface 5 of the second metal plate 3b from being scratched, it is preferable to dispose a shim 72 made of copper or the like softer than the metal plate 3 between the distal end 22 of the upper pressing mechanism 20 and the outer peripheral surface 5 of the second metal plate 3b. Then, the part of the first edge 6a of the second metal plate 3b and the part of the second edge 6b of the first metal plate 3a are made to face each other in the circumferential direction Dc such that the outer peripheral surface 5 of the second metal plate 3b and the outer peripheral surface 5 of the first metal plate 3a are substantially coplanar (edge facing treatment step S7). Since the edge facing treatment step S7 is executed during the execution of the movement restriction step S6, the edge facing treatment step S7 can be executed in a state where the movement or inclination of the temporary assembly plate group 9 is restricted.

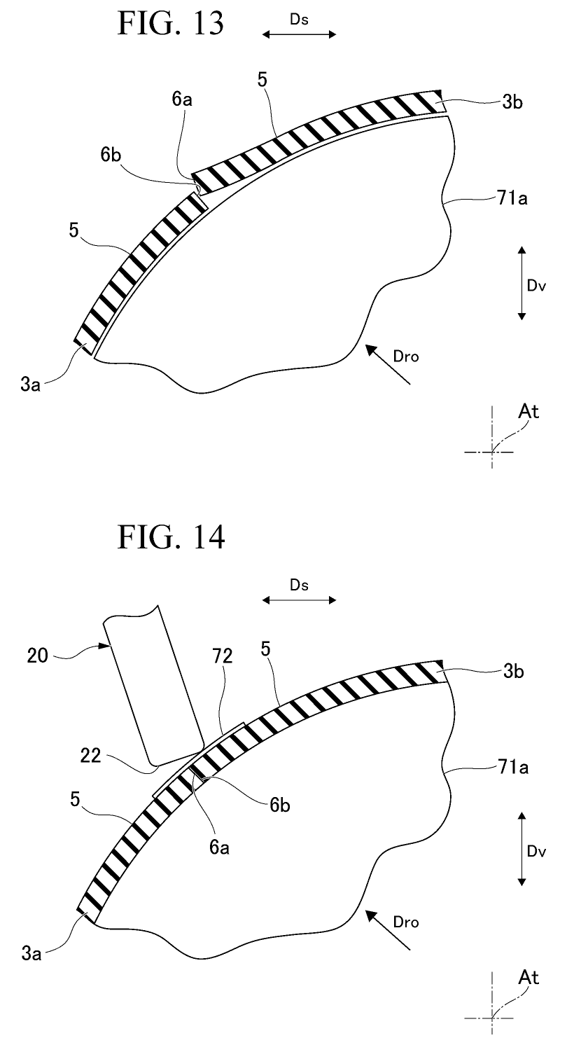

It should be noted that, as shown in FIG. 13, since the part of the first edge 6a of the second metal plate 3b is located on the radial outer side Dro with respect to the part of the second edge 6b of the first metal plate 3a with respect to the tube axis line At, the part of the outer peripheral surface 5 of the second metal plate 3b along the part of the first edge 6a of the second metal plate 3b is pressed by the upper pressing mechanism 20 in a direction having a component in the vertical downward direction. However, in a case where the part of the second edge 6b of the first metal plate 3a is located on the radial outer side Dro with respect to the part of the first edge 6a of the second metal plate 3b with respect to the tube axis line At, in the edge facing treatment step S7, a part of the outer peripheral surface 5 of the first metal plate 3a along the part of the second edge 6b of the first metal plate 3a is pressed by the upper pressing mechanism 20 in a direction having a component in the vertical downward direction.

Next, during the execution of the movement restriction step S6 and during the execution of the edge facing treatment step S7, the part of the first edge 6a of the second metal plate 3b and the part of the second edge 6b of the first metal plate 3a are joined (joining step S8). Since the joining step S8 is executed during the execution of the movement restriction step S6, the joining step S8 can be executed in a state in which the movement or inclination of the temporary assembly plate group 9 is restricted.

Next, the worker determines whether or not the entire edge 6 of the second metal plate 3b is joined to the edges 6 of the first metal plate 3a and the third metal plate 3c (first determination step S9). In a case where the entire edge 6 of the second metal plate 3b is not joined to the edges 6 of the first metal plate 3a and the third metal plate 3c, the steps S5 to S9 described above are repeatedly executed until the entire edge 6 of the second metal plate 3b is joined to the edges 6 of the first metal plate 3a and the third metal plate 3c.

In a case where the worker determines in the first determination step S9 that the entire edge 6 of the second metal plate 3b is joined to the edges 6 of the first metal plate 3a and the third metal plate 3c, it is determined whether or not all the metal plates 3 are joined (second determination step S10). In a case where it is determined that all the metal plates 3 are not joined to each other, the steps S4 to S10 described above are repeatedly executed until all the metal plates 3 are joined to each other.

For example, in a case where it is determined in the second determination step S10 that the fourth metal plate 3d is not joined to the other metal plates 3, the joint plate disposition step S4 is executed on the fourth metal plate 3d, and then the steps S5 to S9 described above are repeatedly executed on the fourth metal plate 3d. Then, in a case where the worker determines in the first determination step S9 that the entire edge 6 of the fourth metal plate 3d is joined to the edges 6 of the first metal plate 3a and the third metal plate 3c, the worker executes the second determination step S10.

In a case where the worker determines in the second determination step S10 that all the metal plates 3 are joined to each other, the first auxiliary metal plate 71a and the second auxiliary metal plate 71b are removed from the temporary assembly plate group 9 (auxiliary plate removal step S11).

The tube 1 is completed as described above.

In the present embodiment, in the position adjustment step S5, in a case where the temporary assembly plate group 9 is moved in the depth direction Dl, the temporary assembly plate group 9 is slid on the slider 60, whereby the burden on the worker in the position adjustment step S5 can be reduced. In addition, in the present embodiment, since the edge facing treatment step S7 and the joining step S8 can be executed in a state where the movement or inclination of the temporary assembly plate group 9 is restricted, the burden on the worker in these steps can be reduced.

### Modification Example

In the above-described embodiment, all of the upper pressing mechanism 20, the first lateral pressing mechanism 20a, and the second lateral pressing mechanism 20b are hydraulic cylinders. However, the pressing mechanisms 20, 20a, and 20b may be, for example, an electromagnetic cylinder, a jack having a link mechanism, or the like.

The slider 60 in the above-described embodiment is a roller conveyor having a plurality of rollers 62 arranged in the depth direction Dl. However, the slider may be any slider as long as a slider can move the object in the depth direction Dl with much less effort than moving the object in the vertical direction Dv and the lateral direction Ds. For example, the slider may be a belt conveyor having a belt extending in the depth direction Dl.

The number of the plurality of metal plates 3 constituting the tube 1 in the above-described embodiment is four. However, the number of metal plates 3 may be any number as long as the number is three or more.

In addition, the present disclosure is not limited to the embodiments described above. Various additions, changes, substitutions, partial deletions, and the like can be made without departing from the conceptual ideas and purposes of the present invention derived from the contents and equivalents thereof described in the claims.

### Appendixes

The tube manufacturing support device M according to the embodiment and the modification example can be understood as follows.

The tube manufacturing support device M according to a first aspect is used in a case of manufacturing a tube 1 by arranging a plurality of metal plates 3 extending in a tube axis direction Da along which a tube axis At extends and spreading in a circumferential direction Dc with respect to the tube axis At, in the circumferential direction Dc around the tube axis At, and joining metal plates 3 adjacent to each other in the circumferential direction Dc among the plurality of metal plates 3.

A tube manufacturing support device M includes a gate-shaped frame 10 including a first column 11a and a second column 11b that extend in a vertical direction Dv and are disposed at intervals in a lateral direction Ds, and an upper beam 12 that extends in the lateral direction Ds and connects an upper end of the first column 11a and an upper end of the second column 11b, a slider 60 configured to support the plurality of metal plates 3 to be movable in a depth direction Dl perpendicular to the lateral direction Ds and the vertical direction Dv between the first column 11a and the second column 11b, an upper pressing mechanism 20 that is attached to the upper beam 12 to be movable in the lateral direction Ds along the upper beam 12 and is configured to press any one of the plurality of metal plates 3 supported by the slider 60, a first lateral pressing mechanism 20a that is attached to the first column 11a and is configured to press any one of the plurality of metal plates 3 supported by the slider 60, and a second lateral pressing mechanism 20b that is attached to the second column 11b and is configured to press any one of the plurality of metal plates 3 supported by the slider 60.

In a case in which the tube 1 is manufactured using the tube manufacturing support device M of the present aspect, the first metal plate 3a and the second metal plate 3b among the plurality of metal plates 3 are arranged to be adjacent to the first metal plate 3a in the circumferential direction Dc (joint plate disposition step S4). Next, the temporary assembly plate group 9 including the first metal plate 3a and the second metal plate 3b is slid in the depth direction Dl on the slider 60 so that a position of the edge 6 of the second metal plate 3b to be joined to the edge 6 of the first metal plate 3a in the tube axis direction Da is located at a work position under the upper beam 12, thereby adjusting a position of the temporary assembly plate group 9 (position adjustment step S5). In the present aspect, in the position adjustment step S5, in a case where the temporary assembly plate group 9 is moved in the depth direction Dl, the temporary assembly plate group 9 is slid on the slider 60, whereby the burden on the worker in the position adjustment step S5 can be reduced.

Next, the first lateral pressing mechanism 20a and the second lateral pressing mechanism 20b are operated to sandwich the temporary assembly plate group 9 positioned at the work position between the first lateral pressing mechanism 20a and the second lateral pressing mechanism 20b, and restricting movement of the temporary assembly plate group 9 (movement restriction step S6). In a case in which the movement restriction step S6 is executed, the temporary assembly plate group 9 is restricted from moving in the lateral direction Ds and the depth direction Dl, and an inclination of the tube axis At and an inclination around the tube axis At are restricted.

Next, during execution of the movement restriction step S6, one portion of a portion along a part of the edge 6 of the first metal plate 3a extending in the tube axis direction Da and a portion along a part of the edge 6 of the second metal plate 3b extending in the tube axis direction Da is pressed by the upper pressing mechanism 20, thereby causing the part of the edge 6 of the first metal plate 3a and the part of the edge 6 of the second metal plate 3b to face each other in the circumferential direction Dc (edge facing treatment step S7). Since the edge facing treatment step S7 is executed during the execution of the movement restriction step S6, the edge facing treatment step S7 can be executed in a state where the movement or inclination of the temporary assembly plate group 9 is restricted. Then, the part of the edge 6 of the first metal plate 3a and the part of the edge 6 of the second metal plate 3b during execution of the movement restriction step S6 and during execution of the edge facing treatment step S7 are joined (joining step S8). Since the joining step S8 is executed during the execution of the movement restriction step S6, the joining step S8 can be executed in a state in which the movement or inclination of the temporary assembly plate group 9 is restricted. Therefore, in the present aspect, the burden on the worker in the edge facing treatment step S7 and the joining step S8 can be reduced.

In the tube manufacturing support device M according to the second aspect, in the tube manufacturing support device M according to the first aspect, each of the upper pressing mechanism 20, the first lateral pressing mechanism 20a, and the second lateral pressing mechanism 20b includes a base 21 and a distal end 22 that is relatively movable to the base 21 in the distal end moving direction.

The base 21 of the upper pressing mechanism 20 is attached to the upper beam 12 such that the distal end moving direction has a component in the vertical direction Dv and the distal end 22 of the upper pressing mechanism 20 faces downward. The base 21 of the first lateral pressing mechanism 20a is attached to the first column 11a such that the distal end moving direction has a component in the lateral direction Ds and the distal end 22 of the first lateral pressing mechanism 20a faces toward the second column 11b. The base 21 of the second lateral pressing mechanism 20b is attached to the second column 11b such that the distal end moving direction has a component in the lateral direction Ds and the distal end 22 of the second lateral pressing mechanism 20b faces toward the first column 11a.

In the tube manufacturing support device M according to the second aspect, the tube manufacturing support device M according to the third aspect includes a first base support frame 40a configured to support the base 21 of the first lateral pressing mechanism 20a and attached to the first column 11a to be movable in the vertical direction Dv, a first support frame moving mechanism 50a configured to move the first base support frame 40a in the vertical direction Dv, a second base support frame 40b configured to support the base 21 of the second lateral pressing mechanism 20b and attached to the second column 11b to be movable in the vertical direction Dv, and a second support frame moving mechanism 50b configured to move the second base support frame 40b in the vertical direction Dv.

In the tube 1, the tube axis At may be bent, or the external size and the external shape of the tube 1 may vary depending on the position of the tube axis direction Da. In the present aspect, even in such a case, the first lateral pressing mechanism 20a and the second lateral pressing mechanism 20b are moved in the vertical direction Dv, so that the temporary assembly plate group 9 can be sandwiched between the distal end 22 of the first lateral pressing mechanism 20a and the distal end 22 of the second lateral pressing mechanism 20b in the movement restriction step S6.

In the tube manufacturing support device M according to the fourth aspect, in the tube manufacturing support device M according to the third aspect, the first base support frame 40a supports the base 21 of the first lateral pressing mechanism 20a to be swingable about a swing shaft 43 extending in the depth direction Dl. The second base support frame 40b supports the base 21 of the second lateral pressing mechanism 20b to be swingable about a swing shaft 43 extending in the depth direction Dl. The tube manufacturing support device M includes a first base swing mechanism 45a attached to the first base support frame 40a and configured to swing the base 21 of the first lateral pressing mechanism 20a about the swing shaft 43 of the first base support frame 40a, and a second base swing mechanism 45b attached to the second base support frame 40b and configured to swing the base 21 of the second lateral pressing mechanism 20b about the swing shaft 43 of the second base support frame 40b.

In the tube 1, the tube axis At may be bent, or the external size and the external shape of the tube 1 may vary depending on the position of the tube axis direction Da. In the present aspect, even in such a case, the movement or the inclination of the temporary assembly plate group 9 in the movement restriction step S6 can be stably restricted by swinging the first lateral pressing mechanism 20a and the second lateral pressing mechanism 20b.

In the tube manufacturing support device M according to the fifth aspect, in the tube manufacturing support device M according to any one of the first aspect to the fourth aspect, the slider 60 includes a pair of roller guides 61 that extend in the depth direction Dl and are disposed between the first column 11a and the second column 11b at intervals in the lateral direction Ds, and a plurality of rollers 62 that are arranged in the depth direction Dl, are disposed between the pair of roller guides 61, and are supported by the pair of roller guides 61 to be rotatable around a roller 62 axis extending in the lateral direction Ds.

In the tube manufacturing support device M according to the sixth aspect, in the tube manufacturing support device M according to any one of first aspect to fifth aspect, in the upper beam 12, a portion including a range in which the upper pressing mechanism 20 is movable in the lateral direction Ds is curved such that the portion gradually inclines upward in the vertical direction from the first column 11a toward a center of the upper beam 12 in the lateral direction Ds and gradually inclines upward in the vertical direction from the second column 11b toward the center.

The plurality of metal plates 3 constituting the tube 1 are basically curved. In the present aspect, since the portion of the upper beam 12 including the range in which the upper pressing mechanism 20 is movable in the lateral direction Ds is curved, the distal end moving direction of the distal end 22 of the upper pressing mechanism 20 with respect to the base 21 of the upper pressing mechanism 20 can be set to an appropriate direction for the curved metal plate 3.

A manufacturing method of the tube 1 according to the embodiment and the modification example can be understood as follows.

In a manufacturing method of the tube 1 according to the seventh aspect, the tube 1 is manufactured using the tube manufacturing support device M according to any one of the first aspect to the sixth aspect.

The manufacturing method includes a preparation step S1 of preparing the plurality of metal plates 3, and, among a first axial side Da1 and a second axial side Da2 in the tube axis direction Da, a first auxiliary metal plate 71a corresponding to an internal size and an internal shape of the tube 1 on the first axial side Da1, and a second auxiliary metal plate 71b corresponding to an internal size and an internal shape of the tube 1 on the second axial side Da2, a temporary joining step S2 of temporarily joining, among the plurality of metal plates 3, a first metal plate 3a and a third metal plate 3c facing each other across the tube axis At to a part of an edge 6 of the first auxiliary metal plate 71a and a part of an edge 6 of the second auxiliary metal plate 71b such that a relative positional relationship between the first metal plate 3a and the third metal plate 3c matches a relative positional relationship between the first metal plate 3a and the third metal plate 3c after the tube 1 is manufactured, a placing step S3 of placing the first metal plate 3a and the third metal plate 3c temporarily joined to the first auxiliary metal plate 71a and the second auxiliary metal plate 71b on the slider 60 such that the tube axis At extends in the depth direction Dl, a joint plate disposition step S4 of disposing, among the plurality of metal plates 3, an edge 6 of a second metal plate 3b, excluding the first metal plate 3a and the third metal plate 3c, the edge 6 facing the circumferential direction Dc and extending in the tube axis direction Da, to be adjacent to an edge 6 of one metal plate 3 of the first metal plate 3a and the third metal plate 3c, which is temporarily joined to the first auxiliary metal plate 71a and the second auxiliary metal plate 71b, the edge 6 facing the circumferential direction Dc and extending in the tube axis direction Da, a position adjustment step S5 of moving, in the depth direction Dl on the slider 60, a temporary assembly plate group 9 that is a set of the first auxiliary metal plate 71a, the second auxiliary metal plate 71b, the first metal plate 3a, the second metal plate 3b, and the third metal plate 3c, so that a position of the edges 6 of the second metal plate 3b to be joined to the edge of the one metal plate 3 in the tube axis direction Da is located at a work position under the upper beam 12, thereby adjusting a position of the temporary assembly plate group 9, a movement restriction step S6 of operating the first lateral pressing mechanism 20a and the second lateral pressing mechanism 20b to sandwich the temporary assembly plate group 9 positioned at the work position between the first lateral pressing mechanism 20a and the second lateral pressing mechanism 20b, thereby restricting movement of the temporary assembly plate group 9, an edge facing treatment step S7 of pressing, during execution of the movement restriction step S6, one of a portion along a part of the edge 6 of the one metal plate 3 extending in the tube axis direction Da and a portion along a part of the edge 6 of the second metal plate 3b extending in the tube axis direction Da by the upper pressing mechanism 20, thereby causing the part of the edge 6 of the one metal plate 3 and the part of the edge 6 of the second metal plate 3b to face each other in the circumferential direction Dc, a joining step S8 of joining the part of the edge 6 of the one metal plate 3 and the part of the edge 6 of the second metal plate 3b during execution of the movement restriction step S6 and during execution of the edge facing treatment step S7, and an auxiliary plate removal step S11 of removing the first auxiliary metal plate 71a and the second auxiliary metal plate 71b from the first metal plate 3a and the third metal plate 3c after the plurality of metal plates 3 are connected to each other. The position adjustment step S5, the movement restriction step S6, the edge facing treatment step S7, and the joining step S8 are repeated until an entirety of the edge 6 of the second metal plate 3b extending in the tube axis direction Da is joined to the edge 6 of the one metal plate 3.

In the manufacturing method of the tube 1 according to the present aspect, the tube manufacturing support device M according to the above-described aspect is used, so that the burden on a worker can be suppressed in manufacturing the tube.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

In the tube manufacturing support device and the tube manufacturing method according to the present disclosure, the burden on the worker can be reduced in the manufacturing of the tube.

### EXPLANATION OF REFERENCES

1: Tube

2a: First opening

2b: Second opening

3: Metal plate

3a: First metal plate

3b: Second metal plate

3c: Third metal plate

3d: Fourth metal plate

4: Inner peripheral surface

5: Outer peripheral surface

6: Edge

6a: First edge

6b: Second edge

9: Temporary assembly plate group

10: Gate-shaped frame

11a: First column

11b: Second column

12: Upper beam

13: Guide hole

20: Upper pressing mechanism

20a: First lateral pressing mechanism

20b: Second lateral pressing mechanism

21: Base

22: Distal end

23: Contact end

30: Upper base support frame

31: Side plate

32: Base insertion hole

33: Bottom plate

34: Lateral movement restriction bolt

40a: First base support frame

40b: Second base support frame

41: Support plate

42: Base holding ring

43: Swing shaft

45a: First base swing mechanism

45b: Second base swing mechanism

46: Swing operation end

47: Swing screw

48: Swing link mechanism

49: Swing screw axis

50a: First support frame moving mechanism

50b: Second support frame moving mechanism

51: Moving operation end

52: Female screw member

53: Connecting member

54: Moving screw axis

60: Slider

61: Roller guide

62: Roller

65: Leg

69: Work plate

71a: First auxiliary metal plate

71b: Second auxiliary metal plate

72: Shim

M: Tube manufacturing support device

At: Tube axis

Da: Tube axis direction

Da1: First axial side

Da2: Second axial side

Dc: Circumferential direction

Dc1: First circumferential side

Dc2: Second circumferential side

Dl: Depth direction

Ds: Lateral direction

Dv: Vertical direction

Dro: Radial outer side

What is claimed is:

1. A tube manufacturing support device used for manufacturing a tube by arranging a plurality of metal plates extending in a tube axis direction along which a tube axis extends and spreading in a circumferential direction with respect to the tube axis, in the circumferential direction around the tube axis, and joining metal plates adjacent to each other in the circumferential direction among the plurality of metal plates, the tube manufacturing support device comprising:
a gate-shaped frame including a first column and a second column that extend in a vertical direction and are disposed at intervals in a lateral direction, and an upper beam that extends in the lateral direction and connects an upper end of the first column and an upper end of the second column;
a slider configured to support the plurality of metal plates to be movable in a depth direction perpendicular to the lateral direction and the vertical direction between the first column and the second column;
an upper pressing mechanism that is attached to the upper beam to be movable in the lateral direction along the upper beam and is configured to press any one of the plurality of metal plates supported by the slider;
a first lateral pressing mechanism that is attached to the first column and is configured to press any one of the plurality of metal plates supported by the slider; and
a second lateral pressing mechanism that is attached to the second column and is configured to press any one of the plurality of metal plates supported by the slider.

2. The tube manufacturing support device according to claim 1, wherein
the upper pressing mechanism, the first lateral pressing mechanism, and the second lateral pressing mechanism each include a base and a distal end that is movable relative to the base in a distal end moving direction,
the base of the upper pressing mechanism is attached to the upper beam such that the distal end moving direction has a component in the vertical direction and the distal end of the upper pressing mechanism faces downward,
the base of the first lateral pressing mechanism is attached to the first column such that the distal end moving direction has a component in the lateral direction and the distal end of the first lateral pressing mechanism faces toward the second column, and
the base of the second lateral pressing mechanism is attached to the second column such that the distal end moving direction has a component in the lateral direction and the distal end of the second lateral pressing mechanism faces toward the first column.

3. The tube manufacturing support device according to claim 2, further comprising:
a first base support frame configured to support the base of the first lateral pressing mechanism and attached to the first column to be movable in the vertical direction;
a first support frame moving mechanism configured to move the first base support frame in the vertical direction;
a second base support frame configured to support the base of the second lateral pressing mechanism and attached to the second column to be movable in the vertical direction; and
a second support frame moving mechanism configured to move the second base support frame in the vertical direction.

4. The tube manufacturing support device according to claim 3, wherein
the first base support frame supports the base of the first lateral pressing mechanism to be swingable about a swing shaft extending in the depth direction,
the second base support frame supports the base of the second lateral pressing mechanism to be swingable about a swing shaft extending in the depth direction, and
the tube manufacturing support device further comprises
a first base swing mechanism attached to the first base support frame and configured to swing the base of the first lateral pressing mechanism about the swing shaft of the first base support frame, and
a second base swing mechanism attached to the second base support frame and configured to swing the base of the second lateral pressing mechanism about the swing shaft of the second base support frame.

5. The tube manufacturing support device according to claim 1, wherein
the slider includes
a pair of roller guides that extend in the depth direction and are disposed between the first column and the second column at intervals in the lateral direction, and
a plurality of rollers that are arranged in the depth direction, are disposed between the pair of roller guides, and are supported by the pair of roller guides to be rotatable around a roller axis extending in the lateral direction.

6. The tube manufacturing support device according to claim 1, wherein
in the upper beam, a portion including a range in which the upper pressing mechanism is movable in the lateral direction is curved such that the portion gradually inclines upward in the vertical direction from the first column toward a center of the upper beam in the lateral direction and gradually inclines upward in the vertical direction from the second column toward the center.

7. A tube manufacturing method of manufacturing a tube using the tube manufacturing support device according to claim 1, the method comprising:
a preparation step of preparing the plurality of metal plates, and, out of a first axial side and a second axial side in the tube axis direction, a first auxiliary metal plate corresponding to an internal size and an internal shape of the tube on the first axial side, and a second auxiliary metal plate corresponding to an internal size and an internal shape of the tube on the second axial side;
a temporary joining step of temporarily joining, among the plurality of metal plates, a first metal plate and a third metal plate facing each other across the tube axis to a part of an edge of the first auxiliary metal plate and a part of an edge of the second auxiliary metal plate such that a relative positional relationship between the first metal plate and the third metal plate matches a relative positional relationship between the first metal plate and the third metal plate after the tube is manufactured;
a placing step of placing the first metal plate and the third metal plate temporarily joined to the first auxiliary metal plate and the second auxiliary metal plate on the slider such that the tube axis extends in the depth direction;
a joint plate disposition step of disposing, among the plurality of metal plates, an edge of a second metal plate, excluding the first metal plate and the third metal plate, the edge facing the circumferential direction and extending in the tube axis direction, to be adjacent to an edge of one metal plate of the first metal plate and the third metal plate, which is temporarily joined to the first auxiliary metal plate and the second auxiliary metal plate, the edge facing the circumferential direction and extending in the tube axis direction;
a position adjustment step of moving, in the depth direction on the slider, a temporary assembly plate group that is a set of the first auxiliary metal plate, the second auxiliary metal plate, the first metal plate, the second metal plate, and the third metal plate, so that a position of the edge of the second metal plate to be joined to the edge of the one metal plate in the tube axis direction is located at a work position under the upper beam, thereby adjusting a position of the temporary assembly plate group;
a movement restriction step of operating the first lateral pressing mechanism and the second lateral pressing mechanism to sandwich the temporary assembly plate group positioned at the work position between the first lateral pressing mechanism and the second lateral pressing mechanism, thereby restricting movement of the temporary assembly plate group;
an edge facing treatment step of pressing, during execution of the movement restriction step, one of a portion along a part of the edge of the one metal plate extending in the tube axis direction and a portion along a part of the edge of the second metal plate extending in the tube axis direction by the upper pressing mechanism, thereby causing the part of the edge of the one metal plate and the part of the edge of the second metal plate to face each other in the circumferential direction;
a joining step of joining the part of the edge of the one metal plate and the part of the edge of the second metal plate during execution of the movement restriction step and during execution of the edge facing treatment step; and
an auxiliary plate removal step of removing the first auxiliary metal plate and the second auxiliary metal plate from the first metal plate and the third metal plate after the plurality of metal plates are connected to each other, wherein
the position adjustment step, the movement restriction step, the edge facing treatment step, and the joining step are repeated until an entirety of the edge of the second metal plate extending in the tube axis direction is joined to the edge of the one metal plate.
